(19) United States
(12) Patent Application Publication
(10) Pub. No.: US 2002/0189754 A1
(43) Pub. Date: Dec. 19, 2002

(54) System and method for forming wood products

(76) Inventor: David A. Hill, Bend, OR (US)

Correspondence Address: KOLISCH HARTWELL, P.C., 520 S.W. YAMHILL STREET, SUITE 200, PORTLAND, OR, 97204, US

(21) Appl. No.: 10/137,666

(22) Filed: Apr. 30, 2002

Related U.S. Application Data
(60) Provisional application No. 60/287,676, filed on Apr. 30, 2001.

(51) Int. Cl. B32B 31/20

(52) U.S. Cl. 156/297; 156/580; 156/578

(57) ABSTRACT

A press assembly includes multiple pressing mechanisms for pressing a composite from multiple non-parallel directions simultaneously.

### CROSS-REFERENCE TO RELATED APPLICATION(S)

This application claims priority under 35 U.S.C. § 119 and applicable foreign and international law of the following U.S. Provisional Patent Application Serial No. 60/287,676 filed Apr. 30, 2001 titled “System and Method for Forming Wood Products” which is hereby incorporated by reference.

This application also incorporates by reference in their entirety for all purposes the following: U.S. Pat. No. 6,214,148 B1 issued Apr. 10, 2001 titled “System for Applying a Wood Veneer Across a Comer of an Elongate Core” and U.S. patent application Ser. No. 10/007,624 filed Mar. 12, 2001 titled “System and Method for Forming Wood Products.”

### FIELD OF THE INVENTION

The present invention relates to engineered wood products, and more particularly systems and methods for bonding components together to form a wood product.

### BACKGROUND

Recent environmental regulations and approaching exhaustion of old-growth timber supplies have made it increasingly difficult and expensive for manufacturers to obtain high-grade lumber to use in their wood products. Such products include furniture, cabinets, and millwork. This is particularly a problem for products which are stained rather than painted because the stain does not cover any underlying irregularities in the wood. With painted products, on the other hand, many of the defects in the wood are covered by the finish.

One way of addressing the shortage and high cost of quality lumber is to use veneered stock. Veneered parts may be created by laminating a high quality, i.e., clear, veneer over a lower grade core material, such as medium density fiberboard (MDF), particle board, oriented strand board, plywood or finger-jointed stock. Use of veneered parts results in a substantially more efficient utilization of high quality wood, and therefore reduces raw material costs. Unfortunately, the actual process of applying the veneer can be relatively complex.

Veneering is relatively simple if only a single flat surface or two opposed flat surfaces, i.e., one or two sides of a piece of plywood, must be covered. However, covering adjacent sides of a core is substantially more difficult. Multiple processing steps may be required to cover adjacent sides. In a first step, veneer is applied and pressed to one of the adjacent sides. The other side of the partially veneered piece may then have to be surfaced or milled to remove excess glue or overhang of the first applied piece of veneer. The second piece of veneer can then be applied and pressed. Lastly, the edges of the second piece of veneer must be milled. Thus, applying veneers to two or more adjacent surfaces is a time-consuming and costly process.

Similar problems are experienced in processes to form composite wood products that require bonding between wood and polymeric materials such as PVC, polystyrene, polypropylene, polyethylene, phenolic paper, and wood composite mixtures.

It is therefore an object of the present invention to provide a system for applying a veneer or polymeric material on two or more adjacent sides of a core without multiple passes through a press.

### SUMMARY OF THE INVENTION

The invention provides apparatus and methods of applying and pressing sheet material on multiple sides of a core, simultaneously. In the preferred embodiment, a press assembly includes a first movable platen member and an associated first drive mechanism that moves the first movable platen member in a first direction towards a first fixed platen member. A second movable platen member is driven by a second drive mechanism in a second direction toward a second fixed platen member. The control mechanism actuates the first and second drive mechanisms to press simultaneously the first and second platen members towards the first and second fixed platen members, respectively.

Another object of the invention is to form cured composite wood products as rapidly as possible, preferably in a total or semi-automated high throughput manufacturing process.

The invention also provides methods for forming wood products. In a preferred embodiment, a core is provided having first and second adjacent sides. A first sheet is applied to the first side of the core, and a second sheet is applied to a second side of the core. The core and sheets are placed into a press. The press has a first platen that is movable in a direction perpendicular to the first side of the core. A second platen is movable in a direction perpendicular to the second side of the core. The first and second platens are then actuated to press the first and second sheets against the first and second sides of the core simultaneously.

Multiple presses may be arranged in a production system. A press may be moved in a cycle between loading and unloading positions. Progression of the press through the cycle may correspond to the cure time of an adhesive.

Press assemblies may be used advantageously in conjunction with rapid curing adhesives that do not require external heat to cure.

### BRIEF DESCRIPTION OF THE FIGURES

FIG. 1 is a perspective view of a veneer sheet.

FIG. 2 is a perspective view of a wood product comprising a core with sheet material bonded on four sides.

FIGS. 2A-C show cross-sectional views of different product configurations manufactured according to the present invention.

FIG. 3 is a schematic top view of a manufacturing system for producing wood products.

FIG. 4 is an enlarged schematic top view of a press station according to the present invention.

FIG. 5 is a side view of the press station shown in FIG. 4.

FIG. 6 is an end view of a press for forming a wood product.

FIG. 7 is a perspective view of a wood product made according to the present invention.

FIG. 8A is a cross-sectional view of a door stile.

FIG. 8B is a partial perspective view of the door stile in FIG. 8A.

FIG. 9 is a schematic side view of the press shown in FIG. 6.

FIG. 10 is a schematic top view of the press shown in FIG. 6.

DESCRIPTION OF BEST MODES

The invention provides improved systems and methods of manufacturing wood products, particularly wood composites that require bonding of sheet material to surfaces of a core, including at least two surfaces that are not parallel to each other. Many wood product configurations may require bonding to non-parallel surfaces. The present invention generally simplifies manufacturing processes, and decreases manufacturing time, cost, and labor.

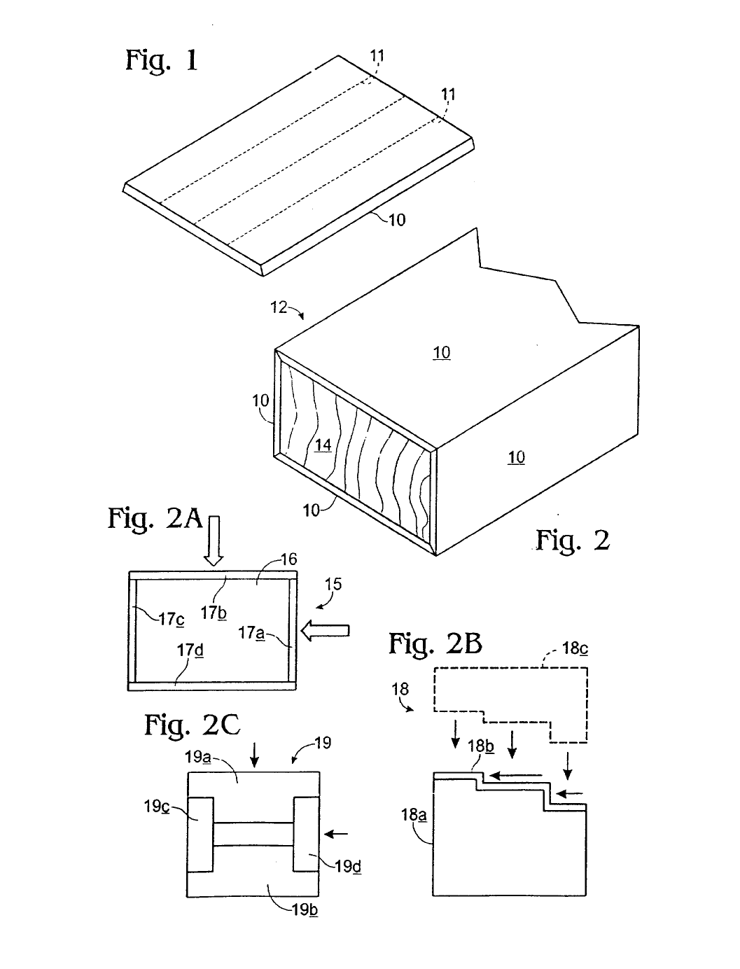

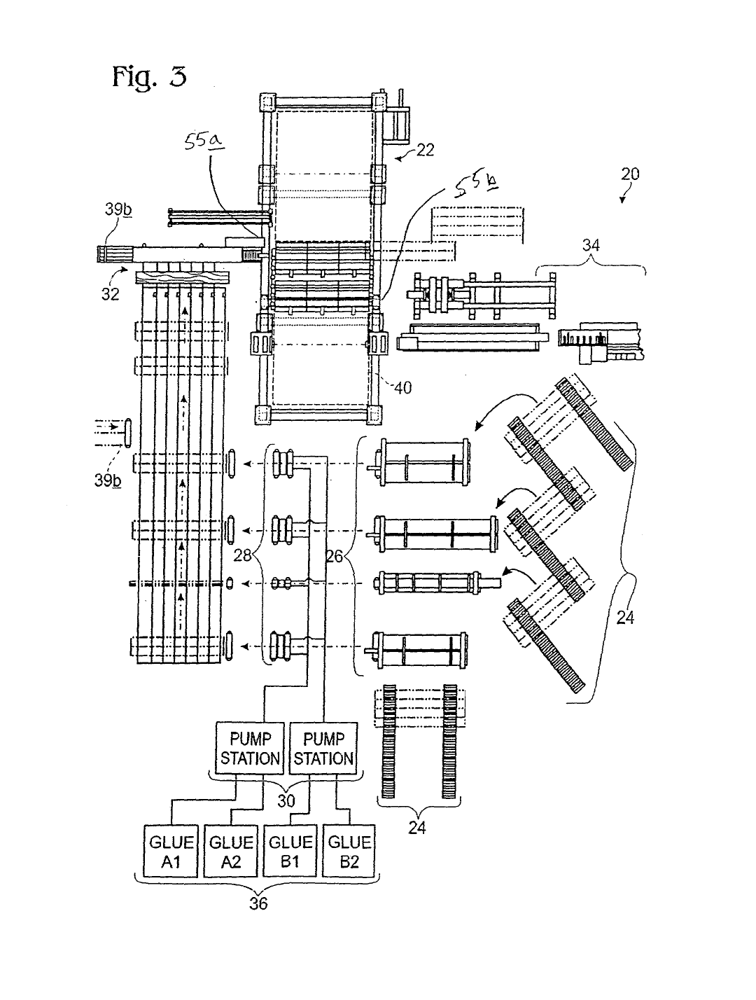

FIG. 1 shows a sheet of veneer 10 having scores or grooves 11. FIG. 2 shows a wood product 12 with veneer sheet 10 bonded on four sides. Veneer sheet 10 may be a continuous sheet or a cut sheet that is suitable for application on wood core 14. Veneer 10 may be cut or grooved along dashed lines 11 to facilitate wrapping of sheet 10 around core 14, according to principles described in U.S. Pat. No. 6,214,148, which is hereby incorporated by reference.

Wood core 14 typically has a quadrilateral shape and is made of a lower-grade material than veneer 10. Wood core 14 may be a wood composite material such as particle board or laminated veneer lumber (LVL). Veneer 10 is bonded to wood core 14 by an adhesive to form a glued veneer-wood core composite. As used herein, the term “composite” refers to a core comprising wood material, and an outer layer of sheet material that may be wood veneer, or polymeric material bonded to the core. The composite may also be referred to as an “article.” The composite in FIG. 2 is pressed from adjacent sides while the adhesive cures.

FIGS. 2A-C show examples of alternative wood composite configurations that may be manufactured according to the present invention. In each case, outer sheet material is applied to a wood core such that pressing is required in more than one non-parallel direction. In FIG. 2A, article 15 includes wood core 16 and four separate outer sheets 17a-d bonded to the four sides of core 16. Satisfactory bonding of sheets 17a-d to core 16 requires pressing in the directions shown by arrows in FIG. 2A.

Similarly, it is sometimes necessary to bond a sheet material around one or more steps of a core, as shown in FIG. 2B. For example, it may be necessary to bond vinyl around a portion of an exterior window frame or door jamb. Core 18a is bonded to sheet material 18b. Sheet material 18b may, for example, be polymeric material such as PVC, polystyrene, polypropylene or polyethylene. Manufactured article 18 requires adhesive bonding between core 18a and sheet material 18b by pressing in the directions of the arrows shown in FIG. 2B. Profiling piece 18c has a profile that complements the step configuration of core 18a, and may be used to distribute pressure evenly across a non-planar surface.

FIG. 2C shows another wood composite 19 in which wood pieces 19a and 19b are milled to have right angle insets or steps. End pieces 19c and 19d are adhesively bonded to the inset regions of 19a and 19b to produce article 19. Pressing is required in the directions shown by arrows in FIG. 2C.

FIG. 3 shows an exemplary environment in which a system 20 and method according to one embodiment of the invention may be carried out. System 20 includes roller assemblies 24 that transfer veneer and wood core materials; veneer and wood core preparation stations 26; glue application stations 28; glue pump stations 30; glue reservoir system 36; assembly station 32; press station 22; and finishing stations 34.

Veneer and wood core pieces are prepared for assembly at preparation stations 26. Preparation may involve simply feeding materials to glue application stations 28 or may include cutting veneer to desired shapes and dimensions suitable for application to a wood core and/or surfacing the veneer for a desired finish. Wood core preparation may include cutting the wood core to a desired shape or dimension.

Glue application stations 28 are located downstream of veneer and wood core preparation stations 26 with a conveying system in between for transferring the veneer and cores. At glue application stations 28, a suspended impingement spray device, such as one of the devices described in U.S. patent application Ser. No. 10/007,624, which is hereby incorporated by reference, is configured to distribute glue onto certain prepared surfaces of veneer, wood cores, and/or other composite pieces. Alternatively, the glue may be applied manually or in another suitable manner.

Pump stations 30 supply pressure for the impingement spray device at glue application stations 28. Pump stations 30 typically are automated and coupled to a glue reservoir and metering system 36. Glue reservoir and metering system 36 includes glue reservoirs, gauges, and/or valves that may be adjusted to provide an optimal mixture of adhesive resin and catalyst so that the gel and/or cure time of the adhesive allows sufficient handling time before pressing while minimizing the cure time of the adhesive in the pressing step. The glue reservoir and metering system may also be equipped with temperature control devices so that predictable, and consistent gel times and viscosities may be maintained. Glues that are used in system 36 are described in U.S. application Ser. No. 10/007,624, which is hereby incorporated by reference.

Assembly station 32 is located upstream of press station 22. Operators assemble the veneer and wood core to form a glued veneer-core composite at assembly station 32. Assembly station 32 may include an automated loader 39 including a flat chain, pusher, and friction-less rails near the inlet of press station 22. Automated loader stations 39a and 39b may be used to deposit prepared wood cores or other materials, with or without glue applied, on to the conveyor heading towards press station 22, thus bypassing preparation stations 26 and/or glue application stations 28.

Finishing stations 34 are located downstream of press station 22 and are configured to remove excess glue and to resurface the veneered article. When resurfacing the veneer, as much as half of the veneer thickness may be removed to obtain a desired finish. Machines used in creating the desired finish may include milling machines, sanders, buffers, and polishers.

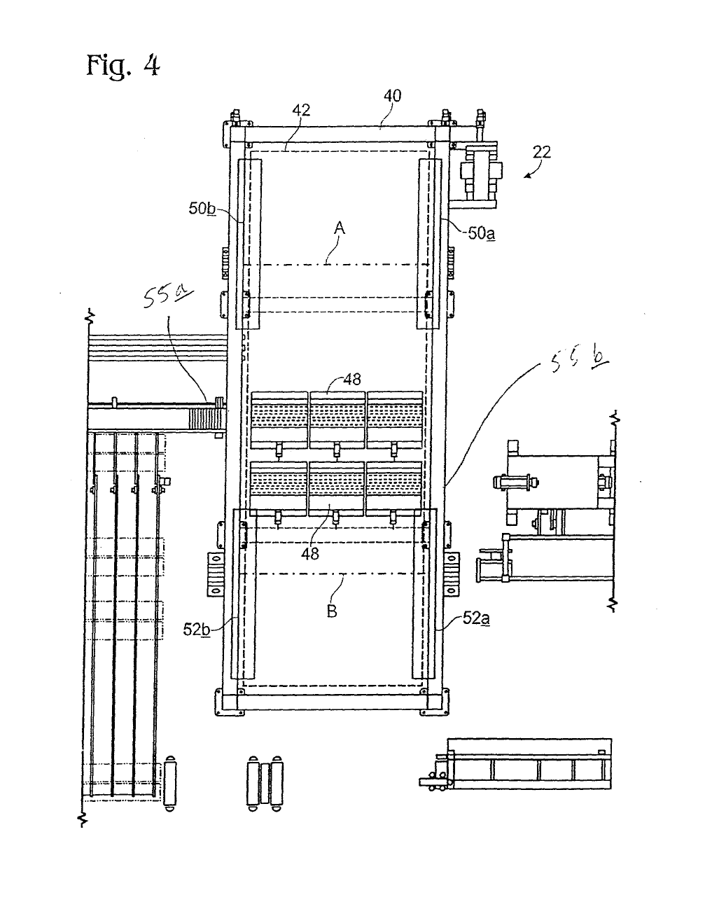

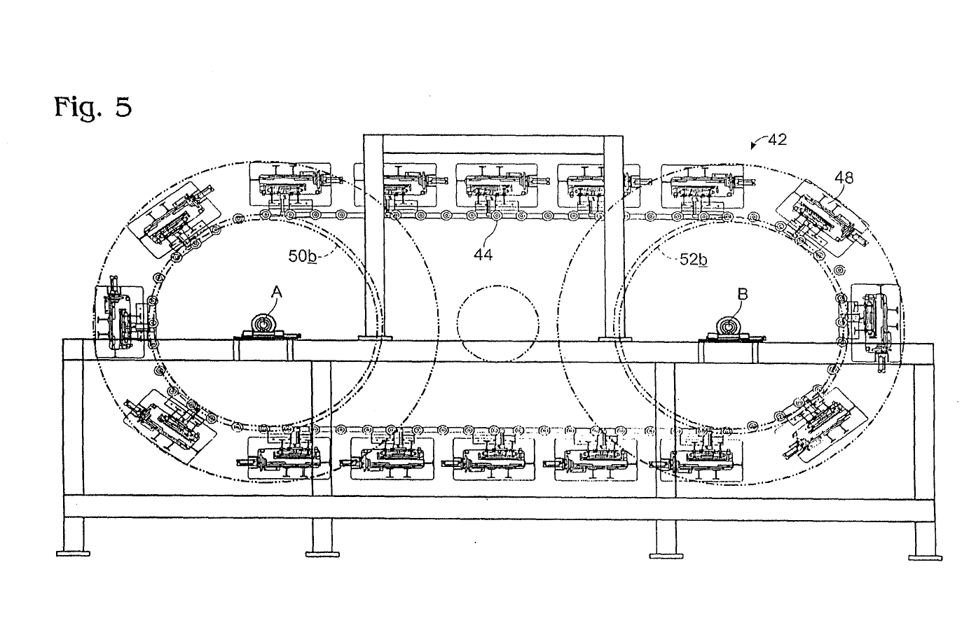

FIGS. 4 and 5 show a carousel assembly of presses used at press station 22. Press station 22 typically includes a frame 40 configured to support a press assembly 42, shown in dashed lines. Press assembly 42 is configured to receive the glued veneer-wood core composite units and to apply pressure to non-parallel sides of the composite during the curing process to form a veneered article.

Press assembly 42 includes a carousel device, and a drive assembly for driving the carousel device to carry presses around a closed-loop path while adhesive curing takes place. Sixteen presses 48 are attached to the carousel device, as shown in FIG. 5. The number of presses may vary, depending on the application. Presses 48 are identically constructed. Alternatively, presses may differ from each other in other embodiments.

As shown in FIGS. 4 and 5, press station 22 includes a pair of flexible tracks such as chains 44 that pass around two pairs of drive wheels 50a, 50b, 52a, and 52b. Drive wheels 50a and 50b rotate around axis A, causing the chains 44 to translate. Each drive wheel is attached to a corresponding axle supported by a mounted bearing and is configured to rotate about its respective axis.

The drive assembly includes a motor, drive shaft, drive sprockets, axles and drive belts. The drive assembly transmits rotational movement about axis A via the axles to rotate drive wheels 50a and 50b. The resulting drive wheel movement about axis A transmits rotational movement via chains 44 to drive wheels 52a and 52b, resulting in all four drive wheels turning in a common direction to drive press assembly 40 in a cycle.

Press assembly 42 is configured to rotate the presses in a complete cycle period, from intake station 55a to output station 55b corresponding to the cure time required for the adhesive. For example, a cycle period of 1-3 minutes may be used for some applications. The cycle period may be adjusted for different applications.

Press station 22 typically is automated and includes a user interface, e.g. a control panel including a keyboard, or other input devices. The user interface allows a user to control the cycling rate of the presses. A panic (or emergency) button is accessible to the operator to immediately stop movement of the press assembly. Press station 22 may also be equipped with an alarm (or audio output device) to signal a problem or alert. The direction of the moving chain assembly may reverse upon receiving an appropriate operator command.

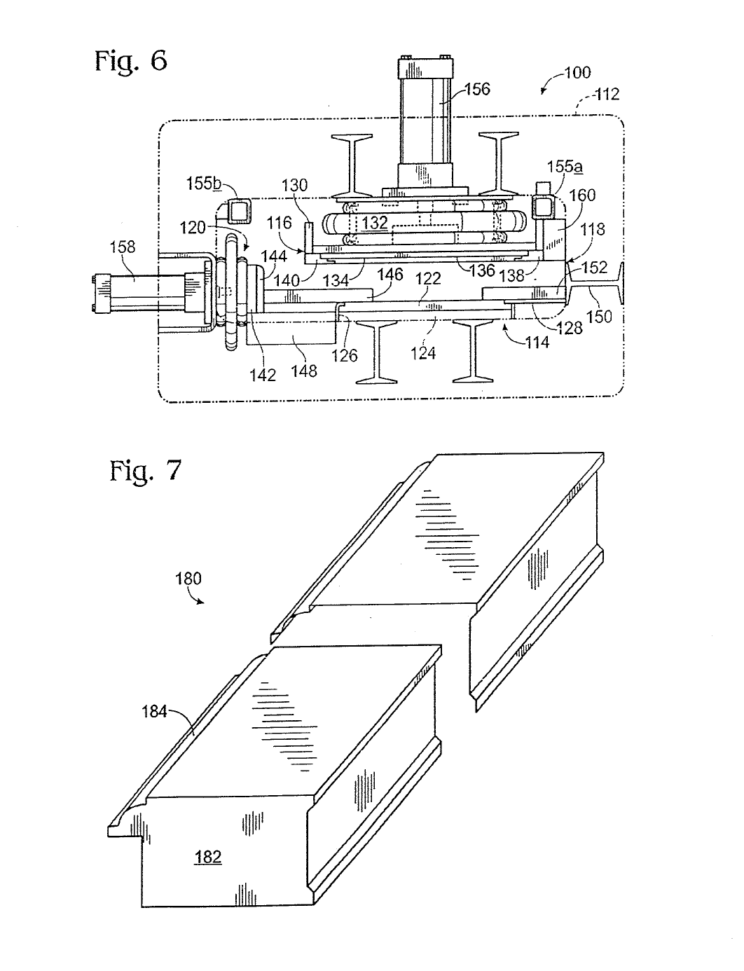

FIG. 6 shows a press 100. Press 100 is configured to supply sufficient pressure to veneer on adjacent non-parallel sides of the composite while the glue cures. Press 100 includes a frame 112 (shown as dotted lines) that supports a fixed lower platen assembly 114, a movable upper platen assembly 116, a fixed side platen assembly 118 and a movable side platen assembly 120. The platen assemblies are configured to exert pressure on the wood core from the sides, top, and bottom simultaneously.

Fixed lower platen assembly 114 includes a sheet 122 of UHMWPE (ultra-high molecular weight polyethylene) on top of a ½″ plate of steel support 124. Sheet 122 is machined with a profile to fit into a slot formed by structural pieces 126 and 128 along both sides of fixed lower platen assembly 114, thereby allowing sheet 122 to slide in and out easily.

Movable top platen assembly 116 consists of a U-shaped metal plate 130 that attaches flush with the bottom face of top actuator 132, a rubber mat 134, a UHMWPE sheet 136, and two side pieces 138 and 140 that receive rubber mat 134 and UHMWPE sheet 136. Each side piece attaches to either side of the bottom of the U-shaped metal plate, thus creating a slot to insert the rubber mat and UHMWPE sheet. To distribute pressure evenly, rubber mat 134 serves as a cushion that helps minimize the effects of any imperfections in the wood core and/or veneer.

Movable side platen assembly 120 includes a platen 142 and an angle iron 144 adapted to receive a thick sheet of UHMWPE 146. Additionally, a thick block of UHMWPE 148, located under the platen and angle iron, functions to support the side platen assembly. Fixed side platen assembly 118 includes an I-beam 150 that lends lateral stability, especially during press usage. A thick sheet of UHMWPE 152 is also generally placed adjacent the I-beam and flat against the lower platen assembly to contact the veneer on the composite.

The movable platen assemblies are pneumatically driven by actuators 132 and 154 to exert pressures of at least about 100 pounds-per-square-inch (psi) on the surface area of the part being pressed. Air manifolds 155a and 155b deliver air to top actuator 132 and side actuator 154, respectively. A block of UHMWPE 160, located below air manifold 155a and permanently attached to top platen assembly 116, is used to prevent the top platen assembly from shifting laterally. UHMWPE is suitable for contacting and applying pressure to a curing composite because it generally does not bond to adhesive. UHMWPE is also desirable for use in the present invention due to the low cost of the material.

Press 100 further includes a retracting mechanism 156 that draws the upper platen assembly upwards to remove pressure from the wooden core. A similar retracting mechanism 158, located within a brace, is situated to withdraw the movable side platen. The retracting mechanisms may also be used to adjust the pressure applied to the wooden core.

The press shown in FIG. 6 is designed to press sheets against sides that form a right angle. It may sometimes be necessary to press simultaneously different sides that are not parallel and do not form a right angle. For this purpose a different press configuration may be built in which the multiple platen members press in directions that are not parallel and do not form a right angle. Additionally, a press may be built so that the direction of pressure exerted by one or both of the platen members is adjustable for different product configurations.

Press configurations may also be used in which platens or profiled inserts are used to bond materials along non-planar interfaces. For example, a UHMWPE sheet may be machined to have a large radius curvature, and then situated in the press to produce a camber calculated to counter or accommodate a predicted camber that occurs when two different materials are bonded together. Similarly, a profiled insert may be used to press vinyl around the contours of a window frame, a door jamb, or other articles having complex profiles. In addition to varied end-view profiles, a press insert may also have a varied side-view profile for other applications. By using appropriate profiling techniques, press 100 may be used to achieve material bonding in an infinite number of different complex product configurations, including both curved and planar surfaces, with only a single pass through the press.

FIG. 7 shows a door stile 180 including a wood core 182 having vinyl cladding 184 over a complex configuration of planar and curved surfaces. Product 180 may be manufactured according to principles discussed above in a single pass through a press.

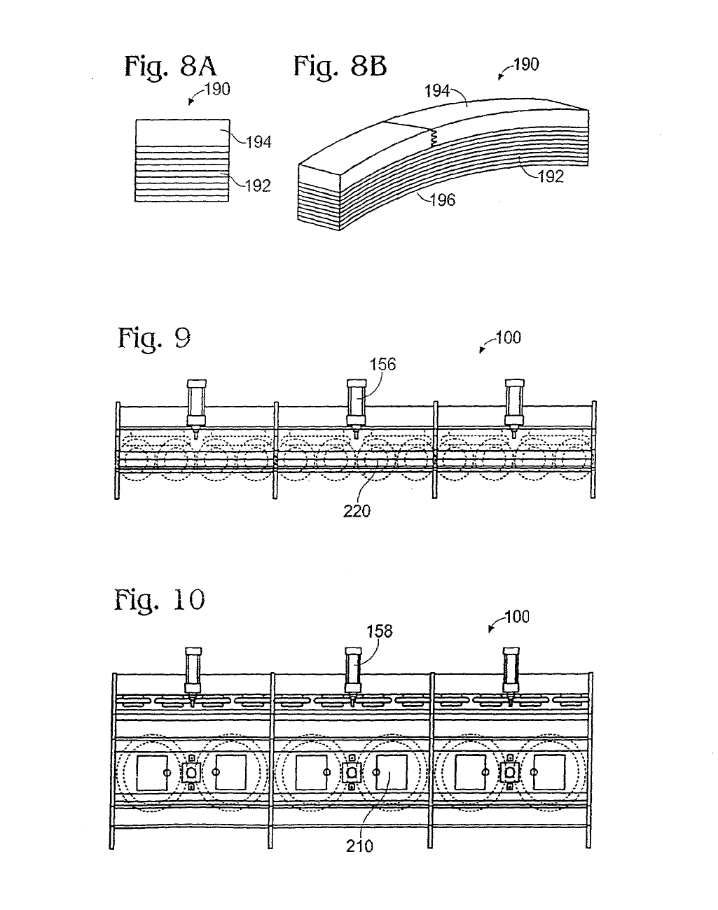

FIGS. 8A and 8B show a door stile 190 including an LVL portion 192 bound to another wood portion 194. Curved profiling techniques, as discussed above, are used to create camber 196 on door stile 190.

FIG. 9 shows a schematic side view of press 100. FIG. 10 shows a schematic top view of press 100. Press 100 includes six top actuators 210 in the movable top platen assembly and twelve side actuators 220 in the movable side platen assembly. Actuators are approximately evenly disposed along the length of the press to distribute pressure evenly.

Press 100 includes three retracting mechanisms 156 on top of the movable top platen assembly and three retracting mechanisms 158 adjacent to the movable side platen assembly as shown in the FIGS. 9 and 10. The retracting mechanisms are approximately evenly disposed along the length of the press to distribute pressure evenly.

Press 100 may also include a user interface to allow an operator to vary the pressure exerted by the platens and to control the movement of the press. Press 100 may also be used as a stand-alone press to produce a composite article in a single-pass application, separate from being used in a carousel assembly with other presses as described above.

A rapid-curing adhesive is typically applied to non-parallel surfaces of a core prior to applying sheet material and inserting the composite into the press. Pressure from the platen assemblies may be exerted in stages, a lesser pressure being exerted in a first stage to verify proper alignment, and a subsequent higher level of pressure being exerted while the adhesive cures. Pressure on the composite is also beneficial in that it aids the distribution of glue on the adhering surfaces.

One of the benefits of the press constructed according to the present invention is that complex composite configurations, which used to require multiple pressing steps, now can be pressed and cured in a single pass through a press. The described system and method can process virtually an unlimited variety of core/laminate/veneer/edging combinations in various sizes without numerous pressing steps.

While the invention has been disclosed in its preferred form, the specific embodiments thereof as disclosed and illustrated herein are not to be considered in a limiting sense as numerous variations are possible. Applicant regards the subject matter of the invention to include all novel and non-obvious combinations and subcombinations of the various elements, features, functions and/or properties disclosed herein. The following claims define certain combinations and subcombinations which are regarded as novel and non-obvious. Other combinations and subcombinations of features, functions, elements and/or properties may be claimed through amendment of the present claims or presentation of new claims in this or a related application.

I claim:

1. A press assembly comprising
a first moveable platen member and associated first drive mechanism that moves the first moveable platen member in a first direction toward a first fixed platen member,
a second moveable platen member and associated second drive mechanism that moves the second platen member in a second direction toward a second fixed platen member, and
a control mechanism that actuates the first and second drive mechanisms to press simultaneously the first and second platen members towards the first and second fixed platen members, respectively.

2. The press assembly of claim 1, wherein the first direction is substantially perpendicular to the second direction.

3. The press assembly of claim 1, wherein the drive mechanisms cause each of the first and second platens to apply a force of at least about 100 pounds-per-square-inch on a pressed surface..

4. The press assembly of claim 1, wherein the drive mechanisms include air-powered actuators.

5. A press assembly for pressing an article having a top, bottom and two sides, comprising
a frame,
a platen assembly connected to the frame configured to clamp the article from the sides and top and bottom simultaneously.

6. The press assembly of claim 5 further comprising a heating device configured to apply heat to adjacent sides of the article.

7. The press assembly of claim 5, wherein the platen assembly includes moveable platens driven by air-powered actuators toward fixed platens.

8. A method of forming a wood product comprising
providing a core having first and second adjacent sides,
applying a first sheet to the first side of the core, and a second sheet to the second side of the core,
placing the core and the sheets into a press having a first platen that is moveable in a direction perpendicular to the first side of the core, and a second platen that is moveable in a direction perpendicular to the second side of the core, and
actuating the first and second platens to press the first and second sheets against the first and second sides of the core simultaneously.

9. The method of claim 8 further comprising
applying glue between the sheets and the core before the placing step.

10. The method of claim 8, wherein each sheet comprises veneer.

11. The method of claim 9, wherein the glue comprises a thermosetting resin.

12. The method of claim 8, wherein the first and second sheets are connected by a hinge structure.

13. The method of claim 8, wherein the first direction is substantially perpendicular to the second direction.

14. The method of claim 8, wherein each of the first and second platens applies at least approximately 10,000 pounds of pressure.

15. The method of claim 8, wherein the actuating step is carried out by air-powered actuators.

16. A method of forming a wood product comprising
impingement spraying an activated mixture of a multi-part rapid curing adhesive onto a first surface of a first material,
contacting the first surface of the first material with a second surface of a second material, and
pressing the first and second surfaces together in a press until the adhesive is substantially cured.

17. A method of forming a wood product comprising
depositing an activated mixture of a multi-part rapid curing adhesive onto a first surface of a first material,
contacting the first surface of the first material with a second surface of a second material, and
applying a non-planar pressing surface to press the first and second surfaces together in a press until the adhesive is substantially cured.

18. A press assembly comprising
a plurality of presses, each press having a first movable platen member and a second moveable platen member, the first and second moveable platen members being configured to press in different directions simultaneously, and
a conveyor device, the presses being mounted on the conveyor device so that each of the presses can be conveyed from an intake station to an output station.

19. The press assembly of claim 18, wherein the conveyor carries the presses along a closed loop path.

20. The press assembly of claim 18, wherein the conveyor includes a carousel, the presses being mounted on the carousel.

21. A pressing system comprising
a plurality of presses mounted on a rotating carousel, each press being moveable around a closed loop path,
an intake station positioned along the path where a workpiece can be loaded into one of the presses, and
an output station positioned along the path where a workpiece can be unloaded from one of the presses.

22. The pressing system of claim 21 further comprising
an adhesive application station configured to apply a rapid-curing multi-part adhesive to the workpiece prior to pressing.

23. The pressing system of claim 22 further comprising
a speed control mechanism connected to the carousel that enables an operator to adjust the speed of the carousel so that adhesive applied to the workpiece is substantially cured just prior to reaching the output station.

24. A pressing system comprising
at least one press mounted along a conveyor configured to move the press from an intake station to an output station,
an adhesive application station located upstream from the conveyor for applying an adhesive having a cure time to a workpiece prior to pressing, and
a speed control device connected to the conveyor that enables an operator to adjust the speed of the conveyor so that the adhesive applied to a workpiece is substantially cured just prior to reaching the output station.

25. The pressing system of claim 24 further comprising
at least one additional press mounted on the conveyor, each press having a first moveable platen member and a second moveable platen member, the first and second moveable platen members being configured to press in different directions simultaneously.

26. The pressing system of claim 24, wherein the conveyor carries the press along a closed loop path.

27. The pressing system of claim 24, wherein the conveyor includes a carousel, the press being mounted on the carousel.

28. A method of forming a composite comprising
applying a rapid-curing multi-part adhesive to a first surface of a workpiece,
contacting the first surface of the workpiece with a material to be bonded to the workpiece,
loading the workpiece and material into a press,
pressing the workpiece, and
conveying the press from an intake station to an output station, wherein the adhesive has a cure time, the timing of the conveying step being selected, based on the cure time of the adhesive, so that the adhesive bonding the workpiece to the material is substantially cured just prior to arriving at the output station.

29. The method of claim 28, wherein the pressing step includes pressing the workpiece in two different directions simultaneously.

30. The method of claim 28, wherein the conveying step includes conveying multiple presses in series from the intake station to the output station.

31. The method of claim 28, wherein the conveying step includes conveying the press along a closed loop path, the intake station and the output station being located along the path.
